(19) United States
(12) Patent Application Publication
(10) Pub. No.: US 2011/0020002 A1
(43) Pub. Date: Jan. 27, 2011

(54) OPTICAL LINE TERMINAL, METHOD FOR OPERATING OPTICAL RECEPTION INTERFACE, AND METHOD FOR PROCESSING CONTINUOUS MODE SIGNAL OF OPTICAL LINE TERMINAL

(75) Inventors: Bin-yeong Yoon, Daejeon-si (KR); Kwang-ok Kim, Jeonju-si (KR); Hark Yoo, Gwangju-si (KR); Mun-seob Lee, Deajeon-si (KR); Jai-sang Koh, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS TELECOMMUNICATIONS RESEARCH INSTITUTE, Daejeon-si (KR)

(21) Appl. No.: 12/812,329

(22) PCT Filed: Apr. 22, 2009
(86) PCT No.: PCT/KR09/02110

§ 371 Date: Sep. 30, 2010

(30) Foreign Application Priority Data
Jul. 16, 2008 (KR) 10-2008-0069106

(51) Int. Cl. H04B 10/20

(52) U.S. Cl. 398/63

(57) ABSTRACT

An Optical Line Terminal (OLT) configuring a Passive Optical Network (PON) is provided. The OLT includes an optical transmitter that transmits an optical signal to Optical Network Units (ONUs) in a downstream direction, an optical receiver that includes general Continuous Mode (CM) signal processing elements to recover clocks and data from optical signals transmitted by ONUs in an upstream direction, and a controller that controls the ONUs such that the optical receiver continuously receives an optical signal. An OLT interface for receiving an optical signal can be implemented using the general CM signal processing elements.

### TECHNICAL FIELD

The present invention relates to a Passive Optical Network (PON), and more particularly, to technology for implementing an interface of an Optical Line Terminal (OLT) to receive optical signals from Optical Network Units (ONUs).

### BACKGROUND ART

In a PON system, multiple ONUs are connected to a port of one OLT through a splitter using optical cable. When the ONUs simultaneously transmit data to an OLT, a collision may occur. To prevent such a collision, a Dynamic Bandwidth Allocation (DBA) algorithm of the OLT allows data transmission by allocating a proper band to an ONU when there is data waiting for transmission in the ONU. An upstream signal from the ONU to the OLT has burst characteristics corresponding to the existence of a data interval and a non-data interval. Since connection distances between the OLT and the ONUs are different, burst characteristics with different optical signal strengths are provided. Due to the burst characteristics, Burst Mode (BM) signal processing elements suitable for a BM signal are implemented in an OLT interface to recover data from a burst signal at high speed. The BM signal processing elements are a BM-Transimpedance Amplifier (BM-TIA), a BM-Limiting Amplifier (BM-LA), a BM-Clock/Data recovery (BM-CDR) element, etc. To conventionally implement the OLT interface of the PON system, the BM-TIA, the BM-LA, and the BM-CDR element should be developed separately, resulting in an increase in the initial cost required to develop a PON OLT system. Since a small number of products are consumed during an initial commercialization stage, element price increases and hence price competitiveness decreases.

### DISCLOSURE OF INVENTION

### Technical Problem

The present invention has been made in view of the above problems. The present invention provides a technical solution for processing a burst signal using general Continuous Mode (CM) signal processing elements, not BM signal processing elements.

### Technical Solution

According to an aspect of the present invention, an OLT configuring a PON includes: an optical transmitter that transmits an optical signal to ONUs in a downstream direction; an optical receiver that includes general CM signal processing elements to recover clocks and data from optical signals transmitted by ONUs in an upstream direction; and a controller that controls the ONUs such that the optical receiver continuously receives an optical signal.

The controller may control the optical signal received by the optical receiver to be continuous except for a guard time for preventing a collision of data transmitted from the ONUs.

According to another aspect of the present invention, an operation method in an OLT configuring a PON includes: performing registration in response to a register request message of an ONU received through an optical receiver including general CM signal processing elements to recover clocks and data from optical signals of a burst form transmitted by ONUs in an upstream direction; and commanding an ONU for transmitting first data after completion of a registration process for registering a non-registered ONU to transmit a valid packet after transmitting an idle frame for a given time.

According to still another aspect of the present invention, an operation method in an ONU configuring a PON includes: receiving a gate message to be transmitted from an OLT to ONUs in order to register a non-registered ONU; and transmitting, when the gate message is received from the OLT in a state in which the ONU is not registered, a register request message to the OLT, the register request message having an attached preamble with a length corresponding to a required time for CM signal processing elements provided in an optical receiver of the OLT to transition from an initial state to a normal state.

### Advantageous Effects

According to the present invention, an OLT interface can be implemented using general CM signal processing elements. Accordingly, the present invention eliminates the need to develop BM signal processing elements suitable for a BM signal. In other words, a PON system can be configured without developing the BM signal processing elements, thereby eliminating the cost required to develop the BM signal processing elements and facilitating initial marketing.

The present invention is effective in terms of development cost.

### BRIEF DESCRIPTION OF DRAWINGS

FIG. 1 is a block diagram of a Time Division Multiple Access (TDMA) PON.

FIG. 2 is a block diagram of a BM interface of an OLT.

FIG. 3 illustrates an example of an optical signal in a BM.

FIG. 4 is a block diagram of the OLT according to the present invention.

FIG. 5 illustrates an example of converting an optical signal of the BM in CM signal processing elements of the OLT according to the present invention.

FIG. 6 is a flowchart of an operation for implementing an optical reception interface with the CM signal processing elements operating in the OLT according to the present invention.

FIG. 7 is a flowchart of a CM signal processing operation of the OLT in an ONU according to the present invention.

### MODE FOR THE INVENTION

The above and other aspects of the present invention will become more apparent by describing preferred exemplary embodiments thereof with reference to the accompanying drawings. These embodiments will be described in detail to enable those skilled in the art to practice the invention.

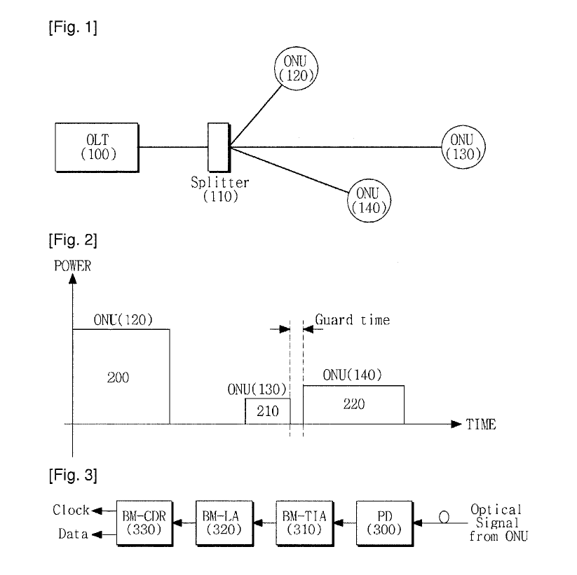

FIG. 1 is a block diagram of a TDMA PON.

In a PON system as shown, ONUs 120, 130, and 140 are connected to a port of one OLT 100 through a splitter 110 using optical cable. In a downstream direction in which data is transmitted from the OLT 100 to the ONUs 120, 130, and 140, each of the ONUs 120, 130, and 140 extracts and receives only its own data. The OLT 100 reports data transmission times to the ONUs 120, 130, and 140 and controls a corresponding ONU to transmit data in a corresponding time in an upstream direction in which data is transmitted from the ONUs 120, 130, and 140 to the OLT 100.

The OLT 100 receives optical signals in a burst form as shown in FIG. 2. In terms of strengths of the received optical signals, an optical signal 200 with relatively high power is received from the ONU 120 close to the OLT 100 and an optical signal 210 with relatively low power is received from the ONU 130 far away from the OLT 100. This is called a burst characteristic according to signal strength. Since the OLT conventionally allows data transmission only when there is data to be transmitted from an ONU, a data interval and a non-data interval are present. This is called a temporal burst characteristic according to whether there is data to be transmitted. To prevent a data collision between the ONUs, the OLT provides a guard time for disabling data transmission from the ONU before and after the ONU transmits data as shown in FIG. 2.

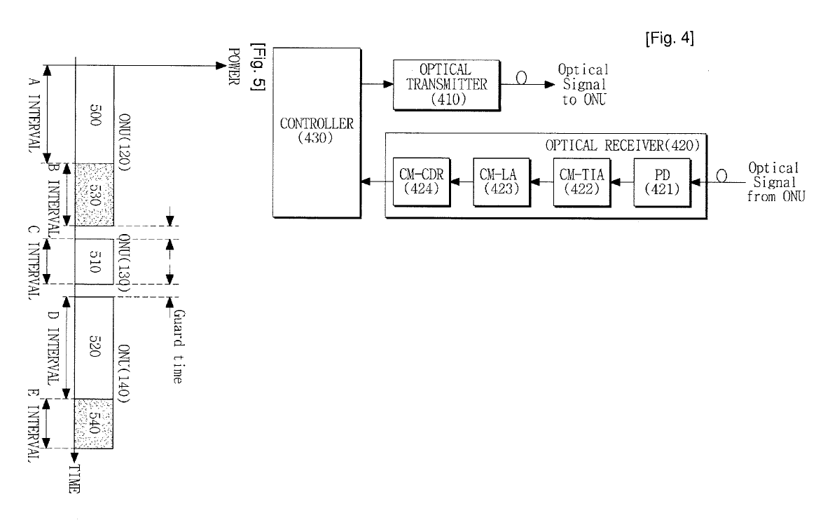

To recover a clock and data from an optical signal in the burst form as shown in FIG. 2, the conventional OLT has an interface including BM signal processing elements 310, 320, and 330 as shown in FIG. 3. A Photodiode (PD) 300 converts a received optical signal into an electrical signal and outputs the electrical signal to the BM-TIA 310. The BM-TIA 310 converts a current signal output from the PD 300 into a voltage signal, amplifies the voltage signal, and outputs the amplified voltage signal to the BM-LA 320. The BM-LA 320 amplifies the voltage signal received from the BM-TIA 310, generates a signal with a given output level, and outputs the generated signal to the BM-CDR element 330. That is, the BM-LA 320 outputs a proper voltage-level signal such that the BM-CDR element 330 can detect a signal of 0 or 1. Then, the BM-CDR element 330 recovers a clock and data from the burst signal output by the BM-LA 320 at high speed.

FIG. 4 is a block diagram of an OLT according to the present invention.

As shown, the OLT includes an optical transmitter 410, an optical receiver 420, and a controller 430. As is well known, the optical transmitter 410 is configured to transmit an optical signal from the OLT 100 to the ONUs 120, 130, and 140. According to a characteristic aspect of the present invention, the optical receiver 420 is implemented with general CM signal processing elements, not existing BM signal processing elements. As shown, the CM signal processing elements are a CM-TIA 422, a CM-LA 423, and a CM-CDR element 424. The CM-TIA 422 converts a current signal from a PD 421 into a voltage signal and amplifies the voltage signal. The CM-LA 423 amplifies the voltage signal received from the CM-TIA 422, generates a signal with a given output level, and outputs the generated signal to the CM-CDR element 424. That is, the CM-LA 423 outputs a proper voltage-level signal such that the CM-CDR element 424 can detect a signal of 0 or 1. Then, the CM-CDR element 424 recovers a clock and data from the burst signal output by the CM-LA 423 at high speed.

However, the optical receiver 420 configured with the CM signal processing elements may not normally process a burst signal as shown in FIG. 3 or may degrade data processing performance. The reason why the signal may not be processed normally is that the transition from an initial state to a normal state is made only when the CM signal processing elements, which have different characteristics from the BM signal processing elements, receive a signal for a given time. Here, the initial state is a state in which a normal operation cannot be performed and the normal state is a state in which the normal operation can be performed. When the burst signal as shown in FIG. 3 is received, received data is lost while the CM signal processing elements transition from the initial state to the normal state according to characteristics of the CM signal processing elements. For reference, when a signal is not received for a give time, the CM signal processing elements transition from the normal state to the initial state at high speed. Data processing performance is remarkably degraded due to burst characteristics according to optical signal strength. Unlike the BM signal processing elements, the CM signal processing elements have a problem in that data processing performance is degraded by the burst characteristics according to optical signal strength.

On the other hand, the controller 430 controls an overall operation of the OLT 100 and the ONUs. Using a well-known Dynamic Bandwidth Allocation (DBA) algorithm, data transmission is allowed by allocating a proper band to an ONU when there is data waiting for transmission in the ONU. According to a characteristic aspect of the present invention, the controller 430 controls the ONUs such that the optical receiver 420 continuously receives an optical signal. Preferably, the controller 430 controls an optical signal received by the optical receiver 420 to be continuous except for a guard time to prevent a collision of data transmitted from the ONUs to the OLT. In other words, the controller 430 controls the ONUs such that data transmission from the ONUs is seamless except for the guard time. Then, the CM signal processing elements 422, 423, and 424 continuously maintain the normal state, thereby preventing loss of data to be received by the optical receiver 420.

Next, a method for preventing loss of data from the ONU to the optical receiver 420 and degradation of data processing performance when the optical receiver 420 is implemented with general CM signal processing elements rather than BM signal processing elements will be described in detail.

As is known, the OLT performs a discovery process and a gating process. The discovery process is a procedure for registering a new ONU in the OLT when the new ONU is added to the PON. The gating process is a process for allocating an available bandwidth from the OLT to an ONU when the OLT system operates normally.

In the discovery process, the controller 430 of the OLT transmits a gate message to all ONUs and waits for a response from the newly added ONU. At this time, the controller 430 controls an existing connected ONU to disable data transmission for a ranging time such that the newly connected ONU can make the response. Accordingly, for the ranging time, the signal processing elements maintain the initial state. When there is a new ONU, the new ONU provides the OLT with a register request message as the response to the gate message. However, since the CM signal processing elements of the optical receiver 420 of the OLT are in the initial state for the ranging time, the new ONU can be normally registered only when the OLT receives the register request message after the CM signal processing elements transition to the normal state.

To normally register a non-registered ONU according to an aspect of the present invention, the non-registered ONU transmits a preamble attached before the register request message when providing the OLT with the register request message as the response to the gate message. Here, it is preferable that a length of the preamble corresponds to a required time when the CM signal processing elements transition from the initial state to the normal state. Since the non-registered ONU transmits the register request message to which the preamble is attached, the CM signal processing elements transition from the initial state to the normal state while the preamble is received, thereby perfectly recovering a clock and data from the register request message received after the preamble. As a result, the controller 430 can normally register a new ONU by receiving a clock and data of a register request message output from the optical receiver 420.

In addition, the controller 430 commands the ONU transmitting the register request message to adjust an optical output level according to signal strength of the register request message received by the optical receiver 420. The signal strength of the register request message received by the optical receiver 420 is monitored by the PD 421. Since it is well known that the PD 421 has a function capable of monitoring the strength of a received optical signal, its detailed description is omitted. The controller 430 checks the signal strength of the register request message monitored by the PD 421 of the optical receiver 420 and transmits a control message for controlling the ONU to adjust an optical output to a proper level according to the checked strength. This is intended to maintain the strength of an optical signal to be received by the optical receiver 420. In other words, to uniformly maintain the strength of optical signals transmitted from the ONUs located at different distances, the controller 430 transmits a control message for commanding the ONU to lower or raise an optical output level when the signal strength of the received register request message is higher or lower than a reference value.

On the other hand, since the OLT does not receive any data for the ranging time from the ONUs after receiving the register request message, the CM signal processing elements 422, 423, and 424 of the optical receiver 420 transition from the normal state to the initial state. Accordingly, there is a problem in that the CM signal processing elements 422, 423, and 424 receive first data transmitted from the ONU after the discovery process in the initial state. According to an aspect of the present invention for addressing the above problem, the OLT controller 430 commands the ONU for transmitting the first data after the discovery process to transmit a valid packet after transmitting an idle frame for a given time. Here, it is preferable that the given time in which the idle frame is transmitted corresponds to a required time for the CM signal processing elements to transition from the initial state to the normal state.

On the other hand, in the gating process, the OLT controller 430 controls the ONU to transmit data only when there is data waiting for transmission in the ONU using the DBA algorithm. As described with reference to FIG. 3, a data transmission interval and a non-transmission interval are present in a time domain. To address a burst problem occurring in the time domain, the OLT controller 430 according to the present invention pre-distributes all spare bands to the ONUs even when there is no data waiting for transmission in the ONUs. The ONU transmits data waiting for transmission using its own allocated band and transmits an idle frame when there is no data to be transmitted.

FIG. 5 illustrates an example of converting an optical signal of the BM of FIG. 3 in the CM signal processing elements of the OLT according to the present invention.

‘A’, ‘B’, and ‘C’ intervals are allocated bands as intervals in which valid packets are transmitted from the ONUs, and ‘D’ and ‘E’ intervals are bands pre-allocated to ONUs as intervals in which there is no valid packet to actually be transmitted in the ONUs. The ONU 120 transmits a valid packet in the ‘A’ interval allocated for valid packet transmission and transmits an idle frame in the ‘D’ interval in which there is no valid packet to be transmitted. The ONU 130 transmits a valid packet in the ‘B’ interval. Since there is no spare band actually, the ONU 130 is not allocated a band for idle frame transmission. The ONU 140 transmits a valid packet in the ‘C’ interval and transmits an idle frame in the ‘E’ interval.

The optical receiver 420 of the OLT 100 continuously receives an optical signal and the CM signal processing elements 422, 423, and 424 continuously maintain the normal state. Of course, an optical signal is not received by the optical receiver 420 in a guard time for preventing a data collision between the ONUs. In general, since the CM signal processing elements have characteristics that maintain the normal state even when a signal is not received during a given interval, normal signal processing is possible by maintaining the normal state for the guard time. Through FIG. 5, it can be seen that all optical signals received from the ONUs 120, 130, and 140 have the same power level. This is because the optical output level of the ONU is adjusted according to signal strength of the register request message in the discovery process as described above.

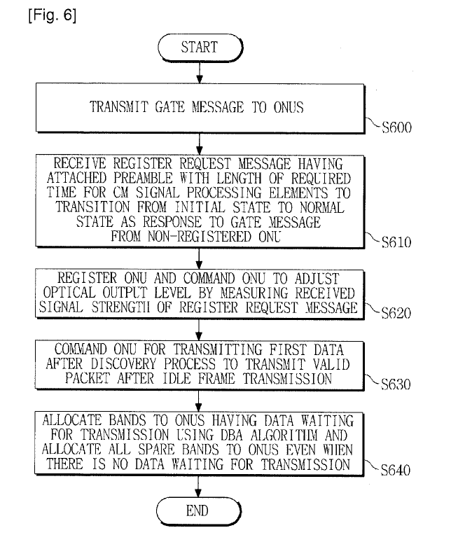

FIG. 6 is a flowchart of an operation for implementing an optical reception interface with the CM signal processing elements operating in the OLT according to the present invention.

In the discovery process, the OLT transmits a gate message to the ONUs (step S600). Then, a register request message with an attached preamble transmitted from the ONU is received as a response to the gate message (step S610). The CM signal processing elements of the optical receiver 420 of the OLT transition from the initial state to the normal state while the preamble is received. Accordingly, the CM signal processing elements of the optical receiver 420 can normally process the register request message received after the preamble. The controller 430 registers a corresponding ONU by receiving the register request message output from the optical receiver 420 (step S620). The controller 430 checks the signal strength of the register request message and transmits a control message for commanding a corresponding ONU to adjust an optical output level (step S620).

Since the OLT does not receive any data from the ONUs for a ranging time after receiving the register request message, the CM signal processing elements of the optical receiver 420 re-transition from the normal state to the initial state. Accordingly, the controller 420 commands the ONU for transmitting first data after the discovery process to transmit a valid packet after transmitting an idle frame for a given time such that the CM signal processing elements of the optical receiver 420 can transition from the initial state to the normal state (step S630). Then, in the gating process, the OLT controller 420 allocates bands to ONUs having data waiting for transmission using the DBA algorithm and allocates all spare bands to the ONUs even when there is no data waiting for transmission (step S640).

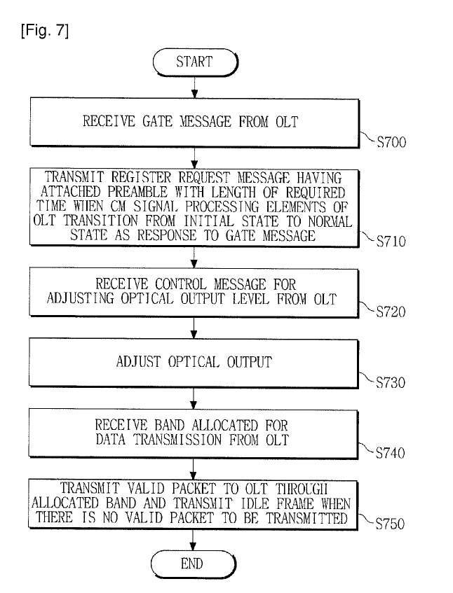

FIG. 7 is a flowchart of a CM signal processing operation of the OLT in an ONU according to the present invention.

In the discovery process, the ONU receives a gate message from the OLT (step S700). In a non-registration state, the ONU provides the OLT with a register request message to which a preamble is attached as a response to the gate message (step S710). Here, the preamble attached before the register request message has a length that is the same as the time taken for the CM signal processing elements configuring the optical receiver 420 of the OLT to transition from the initial state to the normal state. After the register request message is transmitted, a control message for adjusting an optical output is received from the OLT receiving the register request message (step S720). In response to the received control message, the optical output is adjusted (step S730). Then, in the gating process, the ONU is allocated a data transmission band from the OLT (step S740). The ONU transmits a valid packet waiting for transmission through the allocated band and transmits an idle frame when there is no packet waiting for transmission (step S750). To transmit first data after the discovery process, the ONU transmits a valid packet after transmitting the idle frame for a given time.

Although the invention has been described with reference to preferred exemplary embodiments, it will be apparent to one of ordinary skill in the art that various modifications may be made to the described embodiments without departing from the spirit and scope of the invention. Accordingly, the disclosed embodiments should be considered in a descriptive rather than a restrictive sense. The scope of the present invention will be defined by the appended claims, and differences within the scope should be understood as included in the present invention.

1. An Optical Line Terminal (OLT) configuring a Passive Optical Network (PON), the OLT comprising;
an optical transmitter that transmits an optical signal to Optical Network Units (ONUs) in a downstream direction;
an optical receiver that comprises general Continuous Mode (CM) signal processing elements to recover clocks and data from optical signals transmitted by ONUs in an upstream direction; and
a controller that controls the ONUs such that the optical receiver continuously receives an optical signal.

2. The OLT of claim 1, wherein the CM signal processing elements comprise at least one of a transimpedance amplifier, a limiting amplifier, and a clock/data recovery element.

3. The OLT of claim 1, wherein the controller controls the optical signal received by the optical receiver to be continuous except for a guard time for preventing a collision of data transmitted from the ONUs.

4. The OLT of claim 3, wherein the controller registers an ONU transmitting a register request message in response to the register request message with an attached preamble received by the optical receiver.

5. The OLT of claim 4, wherein a length of the preamble corresponds to a required time for the CM signal processing elements to transition from an initial state to a normal state.

6. The OLT of claim 4, wherein the controller commands the ONU transmitting the register request message to adjust an optical output level according to optical signal strength of the received register request message.

7. The OLT of claim 6, wherein the controller makes a command to adjust the optical output level such that the strength of the optical signal received by the optical receiver is regular.

8. The OLT of claim 3, wherein the controller commands an ONU for transmitting first data after completion of an ONU registration process to transmit a valid packet after transmitting an idle frame for a given time.

9. The OLT of claim 8, wherein the controller makes a command to transmit the valid packet after transmitting the idle frame for a required time for the CM signal processing elements to transition from an initial state to a normal state.

10. The OLT of claim 3, wherein the controller allows data transmission by allocating a band to an ONU having data waiting for transmission when allocating available bandwidths to ONUs, and pre-allocates all spare bands even when there is no data waiting for transmission in the ONUs.

11. The OLT of claim 10, wherein a band for idle frame transmission from the ONU is allocated to the ONU even when there is no data waiting for transmission.

12. A method for implementing and operating an optical reception interface in an OLT configuring a PON, the method comprising:
performing registration in response to a register request message of an ONU received through an optical receiver comprising general CM signal processing elements to recover clocks and data from optical signals of a burst form transmitted by ONUs in an upstream direction; and
commanding an ONU for transmitting first data after completion of a registration process for registering a non-registered ONU to transmit a valid packet after transmitting an idle frame for a given time.

13. The method of claim 12, wherein the register request message is a message to which a preamble is attached, the preamble having a length of a required time for the CM signal processing elements to transition from an initial state to a normal state.

14. The method of claim 12, wherein the commanding of the ONU to transmit the valid packet comprises:
making a command to transmit the valid packet after transmitting the idle frame for a required time for the CM signal processing elements to transition from an initial state to a normal state.

15. The method of claim 12, further comprising:
commanding the ONU transmitting the register request message to adjust an optical output level according to optical signal strength of the received register request message.

16. The method of claim 15, wherein the commanding of the ONU to adjust the optical output level comprises:
making a command to adjust the optical output level such that the strength of the optical signal received by the optical receiver is regular.

17. The method of claim 12, further comprising:
allowing data transmission by allocating a band to an ONU having data waiting for transmission when allocating available bandwidths to ONUs; and
pre-allocating all spare bands even when there is no data waiting for transmission in the ONUs.

18. An optical signal transmission method for processing a CM signal of an OLT in an ONU configuring a PON, the method comprising:
receiving a gate message to be transmitted from the OLT to ONUs in order to register a non-registered ONU; and
transmitting, when the gate message is received from the OLT in a state in which the ONU is not registered, a register request message to the OLT, the register request message having an attached preamble with a length corresponding to a required time for CM signal processing elements provided in an optical receiver of the OLT to transition from an initial state to a normal state.

19. The optical signal transmission method of claim 18, further comprising:
receiving a control message for adjusting an optical output level from the OLT receiving the register request message; and
adjusting the optical output level in response to the control message.

20. The optical signal transmission method of claim 18, further comprising:
transmitting data waiting for transmission through a band allocated from the OLT; and
transmitting an idle frame through an allocated band when there is no data waiting for transmission.
